(19) United States
(12) Patent Application Publication
(10) Pub. No.: US 2004/0208627 A1
(43) Pub. Date: Oct. 21, 2004

(54) Optical signal transmission method

(76) Inventors: Farhad Hakimi, Watertown, MA (US); Hosain Hakimi, Watertown, MA (US)

Correspondence Address: WILMER CUTLER PICKERING HALE AND DORR LLP, 60 STATE STREET, BOSTON, MA, 02109, US

(21) Appl. No.: 10/211,145

(22) Filed: Aug. 2, 2002

(51) Int. Cl. H04B 10/04

(52) U.S. Cl. 398/161

(57) ABSTRACT

An optical communication system and method are disclosed. Optical communication may be implemented with less complicated and costly components yet use RZ-like signal formats. The method may also be adapted to provide communication with beneficial phase relationships among optical pulses. An originating signal has a plurality of pulses, each pulse defined by a leading edge and a falling edge. A plurality of first optical pulses are created and transmitted on an optical communication medium in which each first optical pulse corresponds to a leading edge of a corresponding pulse of the originating signal. A plurality of second optical pulses are created and transmitted on an optical communication medium in which each second optical pulse corresponds to a falling edge of a corresponding pulse of the originating signal.

### CROSS-REFERENCE TO RELATED APPLICATIONS

This application claims the benefit of U.S. Provisional Application No. 60/382,848, entitled “All Optical NRZ to RZ Format Conversion Using an Interferometer” filed on May 23, 2002, which is hereby incorporated by reference in its entirety.

### BACKGROUND

1. Field of the Invention

This invention generally relates to optical communication and in particular to optical communication systems and methods using a RZ-like format of an underlying data signal.

2. Discussion of Related Art

Return-to-Zero (RZ) format has certain benefits over Not Return-to-Zero (NRZ) for fiber optic communication. One advantage of RZ stems from the fact that RZ pulses are less prone to effects of non linearity in the fiber, such as self phase modulation (SPM). Hence RZ format results in more robust communications. Additionally, the RZ format can support soliton transmission that has shown better tolerance to a particular impairment in the fibers, called polarization mode dispersion (PMD). (See U.S. pat. apl. Ser. No. 10/138,717, filed May 3, 2002, assigned to the assignees of this application, which is hereby incorporated by reference in its entirety.)

However, the components needed to generate RZ format requires higher electrical (RF) and optical bandwidth (e.g., 25% to 50%). This, in turn, translates to higher complexity and cost. As the data rates increases, the bandwidth needed to generate RZ signals increases as well, complicating the task.

### SUMMARY

The invention provides methods of optical communication that may be implemented with less complicated and costly components. The method may also be adapted to provide communication with beneficial phase relationships among optical pulses.

According to one aspect of the invention, an originating signal has a plurality of pulses, each pulse defined by a leading edge and a falling edge. A plurality of first optical pulses are created and transmitted on an optical communication medium in which each first optical pulse corresponds to a leading edge of a corresponding pulse of the originating signal. A plurality of second optical pulses are created and transmitted on an optical communication medium in which each second optical pulse corresponds to a falling edge of a corresponding pulse of the originating signal.

According to another aspect of the invention, the originating signal is an NRZ signal.

According to another aspect of the invention, the originating signal is an optical signal.

According to another aspect of the invention, each first pulse and corresponding second pulse has a phase difference of about π radian.

According to another aspect of the invention, the originating signal has a data rate and the first and second optical pulses are created by providing the originating signal to an interferometer having two legs in which one leg has a time delay relative to the other, and wherein the time delay is a fraction of the data period.

According to another aspect of the invention, the first and second optical pulses are received and an NRZ signal is created therefrom.

According to another aspect of the invention, the first and second optical pulses are converted to an electrical representation of the first and second optical pulses, and the electrical representation of the first and second optical pulses is received by a toggle circuit.

### BRIEF DESCRIPTION OF THE DRAWINGS

In the Drawing,

FIG. 1 is a block diagram of exemplary transmission components according to certain embodiments of the invention;

FIG. 2 illustrates various signal formats according to certain embodiments of the invention; and

FIG. 3 illustrates an optical communication system, including receiver components according to certain embodiments of the invention.

### DETAILED DESCRIPTION

Preferred embodiments of the present invention generate an RZ-like signal, passively via all optical conversion of an NRZ signal. The RZ-like signal is not a RZ format of the underlying data signal but is an RZ version of an NRZ form of the underlying data signal. The RZ-like signal has beneficial phase relationships among the pulses. As will be explained below, preferred embodiments do not require the complicated, costly, high-bandwidth components necessary for conventional RZ communication.

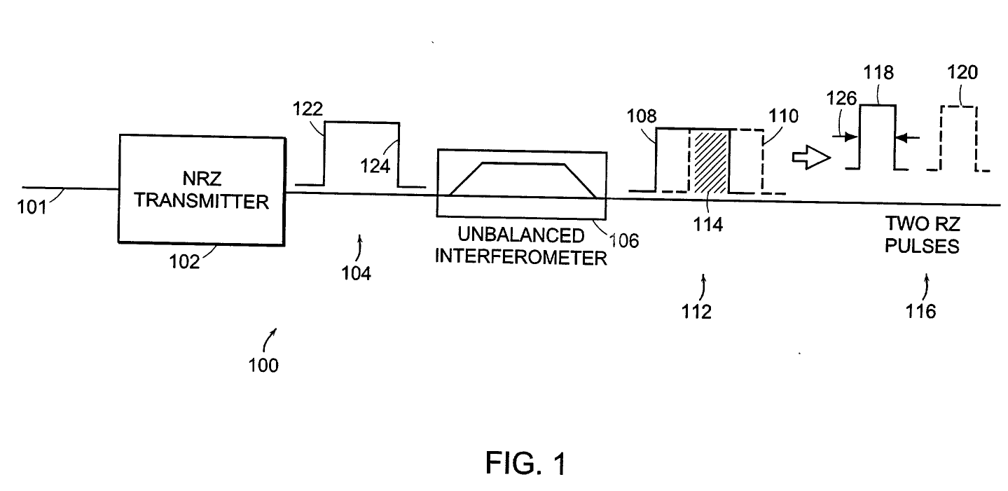

FIG. 1 is a block diagram of an exemplary system 100 according to certain embodiments of the invention. A data signal is provided to NRZ transmitter 102, which emits an optical NRZ signal 104. NRZ signal 104 is fed into an unbalanced interferometer 106 with one arm delayed relative to other preferably by about half the bit period of the data signal and with one arm phased set at preferable π radian relative to the other. (The time delay is preferably a fraction of a bit period.) One arm of the unbalanced interferometer 106 creates a pulse 108 and the other arm creates a pulse 110 that is time-overlapping and phase-shifted relative to the other. The superimposed pulses are depicted conceptually by 112. As indicated by the shaded area 114, the two pulses 108, 110 each have portions that destructively interfere. As shown conceptually, by detail 116, the result of the destructive interference is two RZ-like pulses 118, 120.

As will be explained below, the two pulses 118, 120 are not necessarily RZ representation of the underlying data signal fed into transmitter 102. Instead, the pulses 118, 120 in effect encode the rising edge 122 and falling edge 124 of the NRZ signal 104. The duration 126 of these generated RZ-like pulses 118, 120 is determined by the delay in the interferometer 106. By adjusting the delay, the time overlap of pulse 108, 110 change, with the resulting width 126 of the non-interfering portions also changing. The RZ-like signal 116 is less prone to fiber impairments such as SPM and PMD than is the NRZ signal. Moreover, the generated signal 116 has Carrier Suppressed RZ spectrum (CSRZ). This is caused by π phase difference pulses generated in the output of the interferometer 106. CSRZ is known to be more robust to cross talks such as cross phase modulation (XPM) and four wave mixing (FWM) in a Wavelength Division Multiplexed (WDM) system.

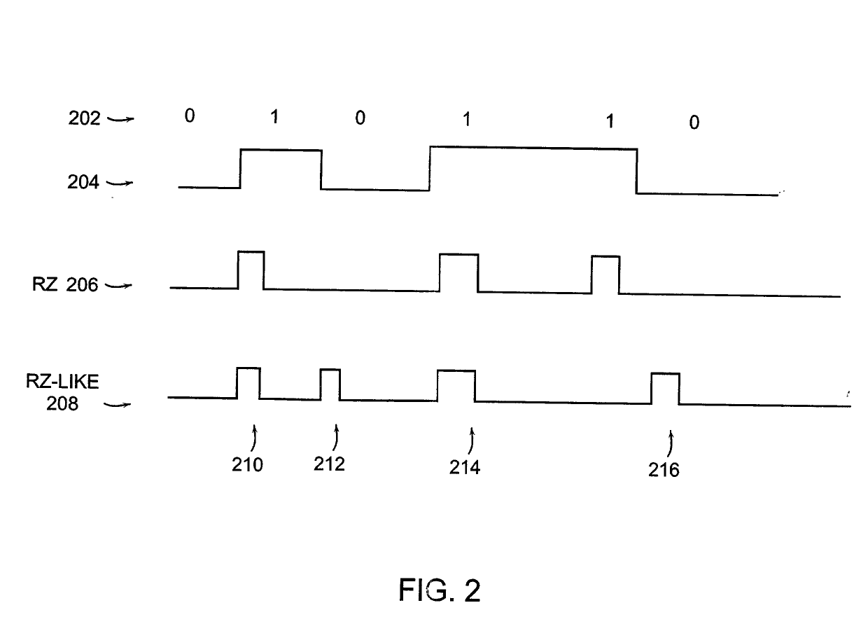

FIG. 2 illustrates the signal formats. An exemplary underlying data signal 202 is shown as a binary stream. A NRZ version thereof is shown as 204. A conventional RZ signal of the underlying signal 202 is shown as 206. An RZ-like signal created by certain embodiments of the invention is shown as 208. Note RZ-like signal 208 differs from conventional RZ signal 206. Under exemplary embodiments, leading pulses 210, 214 correspond to leading edges of the corresponding NRZ signal 204. Trailing pulses 212, 216 correspond to trailing edges of the corresponding NRZ signal 204. The leading and corresponding trailing pulses preferably have a phase difference of π.

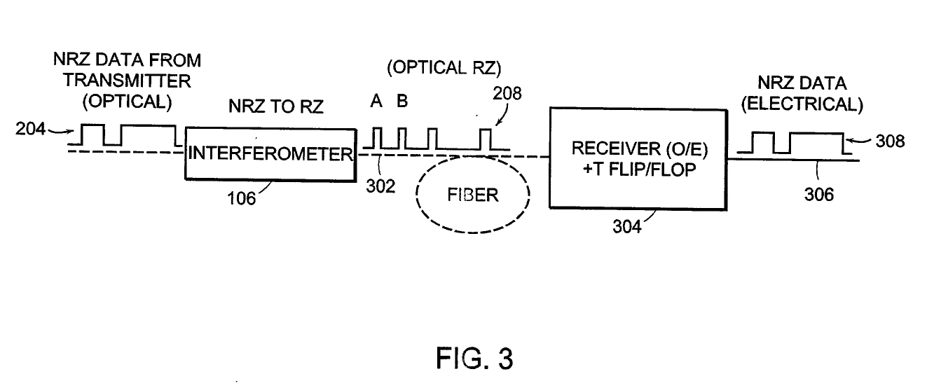

FIG. 3 illustrates a communication system including the transmission system described above and including a receiver 304. An optical NRZ signal 204 is received by the interferometer 106, like those described above. The interferometer produced an RZ-like signal 208, as described above and transmits such over fiber 302. (Fiber is shown conceptually; various repeaters and the like being omitted for simplicity.) The signal 208 is then received by optical receiver 304.

Receiver 304 performs an Optical to Electrical conversion (O/E) of the received signal 208 to create an electrical version thereof (e.g., same pulse shape and duration but in electrical domain). The electrical version of the signal 208 is then processed, in certain embodiments, using a toggle flip-flop (T flip-flop) circuit (not shown). With such a circuit, a pulse (or leading edge thereof) changes the state of the output of the circuit (i.e., the state toggles). The output remains in that state until another pulse is received, which toggles the state again. That is, upon arrival of any RZ pulse at the toggle circuit, the toggle circuit output changes state from 0 to 1 or from 1 to 0, depending on the state of the circuit when the pulse arrives. The result of such an operation is that the RZ-like signal 208 when processed by the toggle circuit creates a reconstitution of the NRZ signal 204, but in the electrical domain. This is illustrated by NRZ signal 308, which is emitted on electrical link 306. This signal may then be processed using conventional circuitry to reconstitute the original underlying signal 204.

Many forms of unbalanced interferometers may be used. For example, Michelson interferometers (MIs) and Mach Zehnder interferometers (MZIs) may be used. Among other things, such approaches may allow tuning of time delay and phase shift, as is known in the art.

In an alternative embodiment, the pulse replicator described in U.S. patent application Ser. No., not yet assigned, entitled “System and Method of Replicating Optical Pulses”, filed on even date herewith, assigned to the assignees of this invention, and naming Hosain Hakimi and Farhad Hakimi as inventors (which is hereby incorporated by reference in its entirety) may be used in place of unbalanced interferometer 106. The round trip time of Fabry Perot interferometer operating in reflection mode determines the delay between the pulses, and the phase difference between the replicated pulses may be adjusted as discussed therein. In certain embodiments, the delay would be approximately on half the bit period, and the phase difference would be approximately π.

It will be further appreciated that the scope of the present invention is not limited to the above-described embodiments, but rather is defined by the appended claims, and that these claims will encompass modifications of and improvements to what has been described.

What is claimed is:

1. A method of optical communication, comprising:
providing an originating signal having a plurality of pulses, each pulse defined by a leading edge and a falling edge;
creating and transmitting on an optical communication medium a plurality of first optical pulses, each first optical pulse corresponding to a leading edge of a corresponding pulse of the originating signal;
creating and transmitting on an optical communication medium a plurality of second optical pulses, each second optical pulse corresponding to a falling edge of a corresponding pulse of the originating signal.

2. The method of claim 1 wherein the originating signal is an NRZ signal.

3. The method of claim 2 wherein the originating signal is an optical signal.

4. The method of claim 1 wherein each first pulse and corresponding second pulse has a phase difference of about π radian.

5. The method of claim 1 wherein the originating signal has a data rate and wherein creating and transmitting first and second optical pulses includes the act of providing the originating signal to an interferometer having two legs in which one leg has a time delay relative to the other, and wherein the time delay is a fraction of the data period.

6. The method of claim 2 further including receiving the first and second optical pulses and creating an NRZ signal therefrom.

7. The method of claim 6 wherein the first and second optical pulses are converted to an electrical representation of the first and second optical pulses, and the electrical representation of the first and second optical pulses is received by a toggle circuit.
